(19) United States
(12) Patent Application Publication
(10) Pub. No.: US 2017/0191966 A1
(43) Pub. Date: Jul. 6, 2017

(54) DISTRIBUTED CIRCLE METHOD FOR GUIDED WAVE BASED CORROSION DETECTION IN PLATE-LIKE STRUCTURES

(71) Applicant: GENERAL ELECTRIC COMPANY, Schenectady, NY (US)

(72) Inventors: Ehsan Dehghan NIRI, Glenville, NY (US); Robert Vincent FALSETTI, Schenectady, NY (US); Curtis Wayne ROSE, Mechanicville, NY (US)

(21) Appl. No.: 14/987,179

(22) Filed: Jan. 4, 2016

(51) Int. Cl. G01N 29/07; G01N 17/00

(52) U.S. Cl. CPC G01N 29/07; G01N 17/00; G01N 2291/106; G01N 2291/0427; G01N 2291/011

(57) ABSTRACT

A system and methods for defect detection and characterization in plate-like structures, more particularly to detect corrosion in complex plate-like structures that result in a deviation in thickness in at least a patch of the structure. The system comprises a plurality of transducers configured to be adjacent to at least a portion of a plate-like structure. A controller is coupled to the plurality of transducers. The method includes propagation of guided waves through the plate-like structure and capture of data to detect the presence of at least one defect using at least a pair of transmitting/receiving transducers based on a change in the velocity of wave transmission as compared to the velocity predicted for a pristine structure. The method also includes estimated localization, and estimation in size and change in thickness of one or more patches using at least four discrete wave transmission paths that traverse the defect by using optimization of a proposed error function to estimate based on distributed circles using a derivative free optimization based algorithm.

### FIELD OF THE INVENTION

The instant disclosure is directed generally to ultrasonic guided wave transducer (sensor) networks and methods of inspection for wall thickness variations in plate-like structures. In some embodiments, the disclosure is more particularly directed to sensor networks and methods for structural health monitoring (SHM) and non-destructive testing using ultrasonic guided waves for corrosion detection and characterization in large-scale, complex, plate-like structures including, but not limited to, storage tank floors, pressure vessels, ship hulls, and aircraft structures.

### BACKGROUND OF THE INVENTION

By some accounts corrosion costs US industries an estimated $170 billion a year. The petrochemical industry takes an above average share of those costs due to the environmental threat if components fail. Corrosion is also a major problem in the aviation industry due to significant damage to airframe structures. The US military spends millions of dollars each year inspecting aircraft structures for corrosion. Traditional point-by-point non-destructive testing (non-destructive testing) methods such as ultrasonic and eddy current inspection have been used for many years to accurately measure wall thickness loss due to corrosion. There are several disadvantages associated with traditional non-destructive testing methods. First, these corrosion detection methods may be very time consuming when inspecting large areas. Second, the potential cost of non-destructive testing techniques may increase if the inspection area is inaccessible. And third, traditional testing methods involve the use of a very large number of sensors which can be costly and contribute to the significant time required for testing.

Guided wave based imaging has received significant interest in recent years. Several algorithms have been developed to screen large areas of pipes and other structures for cracks and corrosion. These methods have been successfully applied in SHM and regular non-destructive testing inspection of pipelines and aircraft structures to provide reconstructed images of corrosion areas. Although the detection and location capability of the existing algorithms is good, the methods generally require a large number of sensors and a high sensor density for accurate image reconstruction which is not economically feasible for most commercial SHM or non-destructive testing systems. Furthermore, many of guided wave imaging techniques cannot quantitatively estimate the remaining wall thickness and size of the corrosion area, but can only provide a qualitative image.

To increase safety and reduce maintenance costs there is a need to establish a reliable and fast corrosion detection method that requires significantly fewer sensors than the known image reconstruction methods that use guided waves. The inventions of the instant disclosure provide such a solution using a very low density of transducers in sensor networks and methods using guided waves in a novel manner for estimating location, wall thickness variation and patch area of corrosion or other wall variation in plate-like structures. The networks and methods can be utilized in development of very simple and fast SHM and/or non-destructive testing techniques and tools for corrosion inspection of plate-like structures.

### SUMMARY OF THE INVENTION

Disclosed are systems and methods for detecting deviations in the thickness of plate-like structures, and in some particular embodiments, detecting and characterizing patches such as corrosion patches in plate-like structures. The systems and methods are useful for providing one or more of estimating location, wall thickness, and patch area, using guided (Lamb) waves at a very low sensor density. In contrast to other detection approaches that use guided waves to provide image reconstruction of a patch, the instant invention beneficially relies on a vastly reduced number of sensors the data from which is processed to provide crucial information about the presence and general location of a wall defect, thickness variation of the detected patch as compared to the thickness of a pristine plate, and size of patches, such as corrosion patches in plate-like structures.

In various embodiments, the disclosure includes novel sensor networks and methods for collecting sensor data and algorithms to provide location, size and thickness information based on time of flight and distributed circle estimations. Importantly, the systems and methods do not rely on the need to measure baseline properties of the plate-like structure. Further, the systems and methods provide a highly cost effective solution to the existing image based methods by relying on only a relatively few sensors (transducers) to provide data sufficient to detect, and estimate the location, size, and depth of a variation in the thickness of the plate. The method changes the theoretical concept of guided wave based tomography and/or imaging approaches needed in corrosion characterization to an estimation problem in order to reduce the number of needed transducers. Application of this system and method to large-scale, complex, plate-like structures, including but not limited to pressure vessels, ship hulls, and aircraft structures, is possible, and within the scope of the attached claims. Moreover, the systems and methods can be applied more broadly to the analysis of other plate-like structures for which data can be obtained using sonography or other modalities that are currently utilized for image reconstruction.

In various embodiments, the disclosure provides methods for characterizing a thickness deviation in at least a portion of a plate-like structure. The methods include deploying adjacent to at least a portion of a plate-like structure a sensor network, where the plate-like structure has a presumed substantially uniform pristine thickness and is formed of an presumed substantially homogenous material and is characterized by known dispersion curvatures that depend on the plate thickness and material properties. In some embodiments the methods include use of a plurality of ultrasonic transducers. The methods further include propagating guided waves through the at least a portion of the plate-like structure within the sensor network, wherein the sensor network provides at least four discrete wave transmission paths that traverse the at least a portion of the plate-like structure. The methods further include determining the velocity of the guided waves along each discrete wave transmission path based on a predetermined distance between sensors that define the path and the time of flight of the transmitted waves along the wave transmission path. The methods further include detecting the presence of any deviation in thickness from the presumed pristine thickness when the determined velocity along at least one of the wave transmission paths deviates from an expected pristine guided wave velocity. The methods further include estimating the location and approximate area of any deviation in the thickness within the at least a portion of the plate-like structure, wherein a deviation in thickness is present when at least four wave transmission paths traverse the deviation as evidenced by a detected deviation of velocity from expected pristine guided wave velocities along at least four wave transmission paths, and whereby the location and size of a patch of thickness deviation is estimated as a circle based on the determined velocities and predetermined distances for each of the transmission paths, and the expected pristine guided wave velocity provided by the known wave mode velocities that depend on the relationship between wavelength and plate thickness.

According to some embodiments, the known guided waves dispersion curvatures, wave mode velocities that depend on the relationship between wavelength and plate thickness are provided by guided ultrasound (Lamb) wave group dispersion curves. In still further embodiments, the sensor network is deployed adjacent to the surface of the plate-like structure and the guided ultrasound waves are propagated between pairs of transducers in the sensor network. Each transducer is paired with another transducer to provide sets of paired transducers comprising a transmitting and a receiving transducer, wherein the sets of paired transducers provides at least four discrete wave transmission paths, each wave transmission path defined between two paired transducers. The velocities of guided waves between the transducers are detected in a dispersed region of fundamental lamb modes, A₀ and S₀ modes (or higher modes), and deviation comprising a decrease in the thickness will result in change in wave velocity, for example a detected reduction in wave velocity in the A₀ mode and a detected increase in wave velocity in the S₀ mode.

In various embodiments, a thickness deviation is characterized by solving for the coordinates for the center and the radius of a circle that estimates the deviation patch, and can be approximated and theoretically calculated as distributed circles for all transducer pairs using a least square optimization problem. In some embodiments, the actual time of flight is determined by one of threshold crossing, cross correlation, and wavelet analysis. In some embodiments, the least square optimization problem is solved by an algorithm selected from derivative free optimization based methods including but not limited to Genetic Algorithm, Particle Swarm Optimization, Mesh Grid Optimization, and coordinate search.

In some embodiments, the deviation is a reduction in thickness caused by corrosion. In some embodiments, the plurality of transducers ranges from at least 2 to more than 20 transducers, and wherein the boundary defines a shape that is selected from a circle, a square and a rectangle, and wherein the plurality of transducers is arranged along at least a portion of the boundary of the corrosion detection area.

In various embodiments, the system comprising a sensor network for corrosion detection in a plate-like structure is provided, which includes a plurality of at least four pairs of transducers arranged along a boundary of a detection area of at least a portion of a plate-like structure, each transducer configured as one of a transmitter that transmits guided ultrasound wave signals, a receiver that receives guided ultrasound wave signals, and a transmitter and a receiver (a dual mode transducer). The plurality of transducers can be configured to enable communication of guided ultrasound waves through the wall of the plate-like structure along a rectilinear path between paired transmitter and receiver transducers. In some embodiments, the boundary defines a detection area that is at least the size of a preselected minimum detection area, such that at least four independent transducer pair paths cross the preselected minimum detection area. The system also includes a controller for actuating the transducers, capturing and processing data obtained from the transmissions between paired transducers, and analyzing the data. In accordance with the methods, the system is used to do one or more of detect, and provide an estimated location of each of one or more corrosion patches within the detection area of the plate-like structure, provide an estimated size of each of the one or more detected corrosion patches, and provide an estimated reduction in thickness of the wall of the plate-like structure within each of the one or more detected corrosion patches, such estimating provided using optimization of a proposed error function. The sensors may be arranged in a shape that is selected from a circle, a square and a rectangle. In some embodiments, adjacent transducers are spaced substantially equidistant. Transducers may be selected from piezoelectric stack transducers, shear piezoelectric transducers, acoustic transducers, electromagnetic acoustic transducers, magnetostrictive transducers, non-contact ultrasound transducers, including but not limited to Laser based ultrasound equipment, air coupled, and EMAT transducers, and combinations of these.

In various embodiments, the sensor network may be portable or may be fixed and in some specific embodiments may be permanently fixed. Thus, in some embodiments, plurality of transducers is fixed on a surface of the plate-like structure, while in other embodiments, the plurality of transducers is portable, and two more of the transducers can be removably positioned on a surface of the plate-like structure. In various embodiments, the network can be moved by robots and other mechanical systems including but not limited to Pig for pipeline inspection. In yet other embodiments, arrangement of each transducer relative to the others is adjustable to enable variable adjustment of the boundary of the detection area.

Advantages realized according to the disclosure include quick, easy-to-apply, guided wave based corrosion patch quantification for plate-like structures, including, for example, large diameter pipelines and airframe structures, and reduction in the number of required sensors as compared to the prior art.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 shows a schematic view of a corrosion patch located between four transducer pairs whose paths go through the corrosion area.

FIG. 2 shows a schematic view of a corrosion patch located between a single transducer pair whose path goes through the corrosion area.

FIG. 3 shows a schematic view of a corrosion patch located between a single transducer pair whose path goes through the corrosion area with a distributed circle.

FIG. 4 shows a graph of a group dispersion curvature for steel plate.

FIG. 5 shows a circular sensor network configuration using 12 sensors.

FIG. 6 shows a circular sensor network configuration using 16 sensors.

FIG. 7 shows a circular sensor network configuration using 20 sensors.

FIG. 8 shows a square sensor network configuration using 12 sensors.

FIG. 9 shows a square sensor network configuration using 16 sensors.

FIG. 10 shows a square sensor network configuration using 20 sensors.

FIG. 11 shows a rectangle sensor network configuration using 12 sensors.

FIG. 12 shows a rectangle sensor network configuration using 16 sensors.

FIG. 13 shows a rectangle sensor network configuration using 20 sensors.

### DETAILED DESCRIPTION OF THE INVENTION

The systems and methods described herein are novel as compared with existing imaging algorithms that provide qualitative or quantitative information using incredibly required high ray density (sensor density) and are not capable of quantifying corrosion by means of providing deviations in thickness in a plate, corrosion location and corrosion area using very low ray density (sensor density). According to the disclosure, one or more thickness deviations may be detected and quantified provided at least four transducer pair paths go through each such deviation. Thus, it will be appreciated that the systems and methods herein are expressly not limited to detection of particular types of deviations in thickness, nor are they limited to detecting any specific number of deviations. Indeed, according to the disclosed methods, deviations of many varieties may be detected, including not only reductions in thickness, but also increases in thickness. Further the methods may be applied to characterization of layers of three dimensional objects that can be represented as layers of plate like structures, and thus the results for multiple layers may be compiled to provide three dimensional characterization of the existence and location of a deviation, as well as its size, and volume. Even further, the methods may be applied to identify and characterize the net extent of deviations, whether in a single plate-like structure or within layers of plate like structures that comprise a three dimensional structure.

According to some embodiments of the disclosure, the systems and methods hereof are employed to provide an estimation of the location of the patch on a plate-like structure, and to estimate variation in the wall thickness from a pristine plate and patch area. The estimations are obtained using guided waves, such as Lamb waves.

Lamb waves are ultrasonic waves that are capable of propagating long distances in a plate due to two traction-free boundaries. Lamb waves have multiple dispersive propagation modes that have been used for many years for non-destructive testing of plate-like structures and can be used to inspect hidden/inaccessible structures like a storage tank floor behind a wall. Lamb waves form several symmetric and antisymmetric modes related to the plate thickness and acoustic frequency of the waves as they propagate through the solid plate structure. Particle displacement within the plate-like structure occurs both in the direction of wave propagation and perpendicular to the plane of the plate. The phase velocity of these modes is dependent on a number of parameters including frequency and can be described graphically by a set of dispersion curves. Referring to the drawings, a representative dispersion curve is shown in FIG. 4, for steel plate.

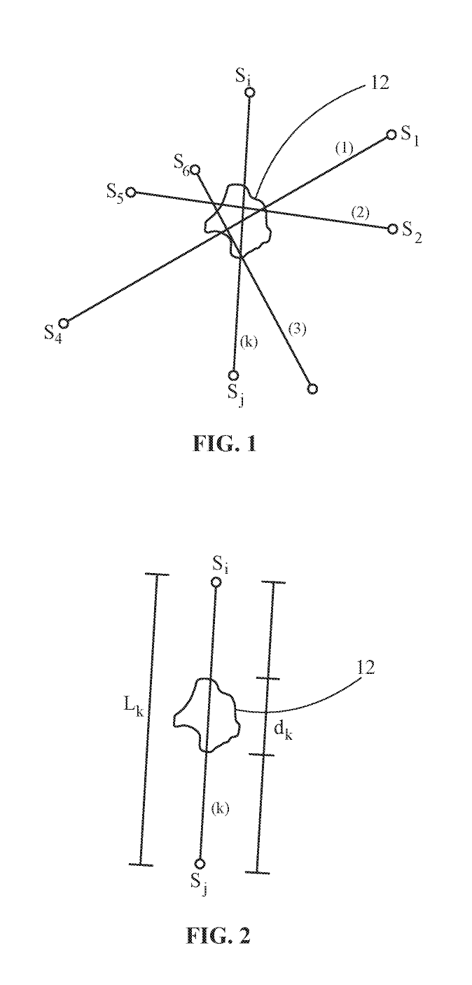

Since A₀ and S₀ Lamb wave modes group wave velocity is dispersive and dependent on plate thickness at specific frequency ranges, A₀ and S₀ Lamb wave modes can be used in Lamb wave tomography for mapping corrosion thickness. It has been demonstrated that if the operational frequency is selected below the first cut-off frequency (i.e., at the intersection of the lines A₀ and S₀) there are two likely regions of operation for A₀ and S₀. Referring again to the drawings, where the plate-like structure is formed of steel, these two ranges are shown in FIG. 4 with heavy solid lines. These frequency ranges are selected below the first cut-off frequency so that the higher Lamb wave modes (not shown in the graph) do not contaminate the relevant signals. It has further been demonstrated that A₀ and S₀ group wave velocity changes as it propagates in the mentioned frequency regions in a patch, for example, in a patch with boundary Γ(x, y), as depicted in FIGS. 1-3. It should be noted that other modes with the same characteristics can be used.

According to the disclosure, data extracted from different pairs of transducers, whose communication paths traverse a corrosion patch, are used to localize and quantify the corrosion. Referring again to FIG. 1, a sensor network represented by S₁-S₆ and Sᵢ-Sⱼ is arranged around the periphery of a detection area, and as shown, each of the sensors is paired with another sensor to provide a sensor communication path, representative paths shown as solid lines and denoted with (1)-(3) and (k). A corrosion patch area 12 representing a corrosion patch on and/or within the wall of a surface of a plate-like structure is shown in FIGS. 1-3, the corrosion patch area 12 defined by a boundary described as Γ(x, y).

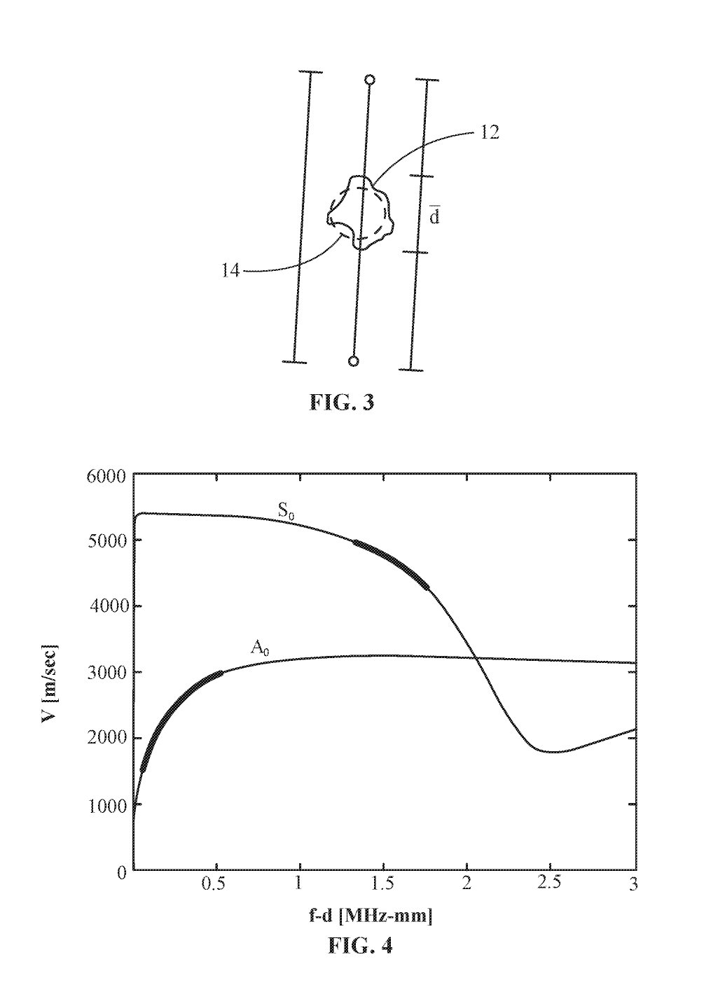

According to the disclosed methods, the corrosion patch boundary Γ(x, y) can be reliably approximated with a distributed circle 14 as shown in FIG. 3, defined as C(x_{c}, y_{c}, r), based on an estimation of the three parameters identifying the circle that include the center point defined by (x_{c}, y_{c}) and a radius r. If thickness reduction in the corrosion area is assumed to be uniform then the thickness of the corrosion area D_{C} can be estimated from wave velocity V̅ estimation of Lamb wave in the corrosion region and using dispersion curvature FIG. 4. This estimation is possible using based on time-of-flight straight ray Lamb wave algorithms so long as at least four transducer communication paths traverse an area of corrosion. Referring again to FIG. 1, the representative corrosion patch area 12 is traversed by four discrete paths, 1, 2, 3, and k, defined respectively by sensor pairs, i-j, 1-4, 2-5, and 3-6 to provide image reconstruction.

There are many examples of approaches where Lamb waves are used to provide image reconstruction of corrosion on a plate-like structure. In accordance with this disclosure, the manner in which Lamb waves are used is different from the prior art in that the data obtained are used not to provide a reconstructed image, but are instead analyzed to detect the presence of corrosion and provide the location, and can as well provide an estimate of the thickness and size through mathematical estimation. Importantly, these are possible without the need to obtain a baseline image or data for the particular structure. The methods herein rely on known properties of guided wave transmissions.

According to the instant disclosure, the value indicated herein above as D_{C} can be estimated as the remnant wall thickness which may be estimated from the wave velocity V in the corrosion area 12. Using A₀ or S₀ Lamb waves with the operational frequency shown in FIG. 4, and having the same dispersion curvature, any change in the expected wave velocity in the pristine plate, V, associated with the operational frequency can be used to estimate the remnant wall thickness. Thus, the corrosion patch having circle parameters C(x_{c}, y_{c}, r) and V can be quantified. To accomplish the estimation of the remnant wall thickness and circle parameters, an optimization problem is constructed to estimate these four values, namely, x, y_{c}, r and V̅, based on the measured time of flight of received signals associated with at least four different transducer pair paths traversing at least one corrosion patch on a corrosion damaged structure.

The system and methods disclosed herein rely on a minimal number of sensors to provide accurate estimation of the area of a corrosion patch, particularly cumulative corrosion area exceeding a minimum threshold amount, and also remnant wall thickness of a corroded area. In contrast, prior art applications of Lamb wave tomography rely on a significantly greater number of transducer pairs to provide image reconstruction detail to accomplish the same corrosion patch size and thickness approximation. Indeed, it is well known in the art to use from as few as about 100 sensors per square meter of a corrosion detection area to as many as 1,500 or more sensors per square meter of detection area.

### Examples

Corrosion Patch Detection and Characterization:

According to an embodiment, sensors that include a transmitter (Sᵢ) and a receiver (Sⱼ) associated with the k-th transmitter/receiver pair, as shown in FIG. 1, are provided and arranged at a peripheral boundary of an area to be monitored.

The total travel time Tₖ along a transducer pair path is shown in Equation 1:

Tₖ=Lₖ/V

where V is the wave velocity in the pristine structure which can be determined from dispersion curvature shown in FIG. 4. Furthermore the Lₖ is the distance between the transducer pair and can be calculated based on the k-th transducer pair locations. After initiation of corrosion the wave velocity in the corrosion patch will change to V̅ and the travel time will change accordingly as shown in Equation 2:

$${\overline{T}}_{k} = \frac{{d}_{k}}{\overline{V}} + \frac{{L}_{k} - {d}_{k}}{V}$$

where dₖ is the portion of the k-th transducer's path inside the corrosion patch area 12 as shown in FIG. 2. Based on the assumption that Γ(x, y) can be approximated by C(x_{c}, y_{c}, r), dₖ length can be approximated by d̅ₖ as shown in FIG. 3 and theoretically calculated for different circle parameters (x_{c}, y_{c}, r), or distributed circles. Based on this assumption, Equation (2) can be modified as shown in Equation 3:

$${\overline{T}}_{k} = \frac{{\overline{d}}_{k}}{\overline{V}} + \frac{{L}_{k} - {\overline{d}}_{k}}{V}$$

It should be noted that if the A₀ mode is used, it is expected to have reduction in wave velocity V in the corrosion area 12, whereas, in contrast, if S₀ is used the wave velocity V will increase due to thickness reduction of the plate. As a result for A₀ the total travel time Tₖ increases whereas Tₖ decreases for S₀. In Equation (2) values of (x_{c}, y_{c}, r) will change the circle location and size, and thus change the value of d̅ₖ. In addition, V is known and can be determined for operating frequency from dispersion curvature.

The actual time of arrival T̅ₖ associated with the k-th transducer pairs can be experimentally measured using received signal Sₖ (t) of the k-th transducer pair. There are several methods for time of arrival measurement such as threshold crossing, cross correlation and wavelet analysis. A common method to estimate the time of arrival difference is threshold crossing. The time of arrival can be measured and compared with the expected time of arrival of the pristine (non-corroded) structure given in Equation (1).

Depending on the guided wave modes and presence of the corrosion three different scenarios are expected. 1) For either of S₀ and A₀ modes the time difference between T̅ₖ and Tₖ is very small indicating there is no reduction in wall thickness and hence no corrosion patch in the path of the k-th transducer pair. 2) In the case that S₀ is excited, the measured time T̅ₖ is greater than Tₖ indicating there is a reduction in the wall thickness in the path of the k-th transducer pair. 3) If A₀ is excited, the measured time T̅ₖ is less than Tₖ indicating there is a reduction in the wall thickness in the path of the k-th transducer pair.

In order to quantify the corrosion patch, a suitable nondestructive testing method using the methods of the instant disclosure can provide information about the boundary Γ(x, y) shown in FIG. 2 and thickness reduction. Based on the approximation of the shape of a corrosion patch as a circle (Γ(x, y)≈C(x_{c}, y_{c}, r)), the nature of the corrosion patch detection is changed to an estimation of the circle parameters. Reduction in wall thickness can be determined if the wave velocity in the corrosion area is estimated. As a result, four unknowns (x_{c}, y_{c}, r, and V̅) in the proposed method should be estimated in order to quantify a corrosion patch. Estimation of these four parameters ideally requires four independent equations that can be derived by setting the difference between measured time of arrival and theoretical time of arrival given in Equation (3) equal to zero, (i.e., T̅ₖ−T̅ₖ==0, K=1 . . . 4). In order to solve these four independent equations, at least four transducer communication paths must traverse a corrosion patch. This number of paths needed to quantify a corrosion patch is much smaller than the required ray density in the corrosion area for a traditional imaging approach such as Lamb wave tomography to quantify a corrosion patch.

To solve these equations, a least square optimization problem is posed with objective function J given as Equation 4:

$$min J ( {x}_{c} , {y}_{c} , r , \overline{V} ) = {\sum }_{k = 1}^{N} {( {\overline{T}}_{k} - {\overline{T}}_{k} )}^{2} , N \geq 4$$

Where N is the number of transducer pairs whose paths go through the corrosion area or their time of arrivals are changed with respect to the time of arrivals of pristine structure given in Equation (1). It is worth noting that the objective function in (4) is not in parametric form. This minimization can be solved using several algorithms such as Genetic Algorithms (GA), Particle Swarm Optimization (PSO), and Mesh Grid Optimization (MGO) or coordinate search.

The change in the nature of the problem from image reconstruction that commonly was used in the literature to an estimation problem, allows the proposed method to quantify the corrosion with less number of transducer pairs and low computational cost. This method can successfully be used in structural health monitoring for corrosion monitoring of plate-like structures. In addition, the method can result in tool development for routine corrosion inspection of pipeline and airframes.

The disclosed method may be used in routine corrosion inspection using guided ultrasonic waves and for SHM application. In various embodiments, there are different configurations of transducers that can be installed permanently or temporarily for real-time SHM for corrosion monitoring of plate-like structures that can benefit from the proposed method. Sensor networks can be provided in a variety of configurations to establish a detection area on a surface. Three representative embodiments of such sensor network configurations include circular, square and rectangular, and other arrangements are possible. According to various embodiments, the number of transducers in a sensor network may range from as few as four (4) transducers and may specifically include 12, 16, and 20 transducers. Of course, the number of transducers may range from and include 4, 5, 6, 7, 8, 9, 10, 11, 12, 13, 14, 15, 16, 17, 18, 19, 20, 30, 40, 50, 60, 70, 80, 90, 100 and more. Without intending to be limiting, transducers that may be used in accordance with the disclosure may be selected from piezoelectric stack transducers, shear piezoelectric transducers, acoustic transducers, electromagnetic acoustic transducers, magnetostrictive transducers, non-contact ultrasound transducers, including but not limited to Laser based ultrasound equipment, air coupled, and EMAT transducers, and combinations of these.

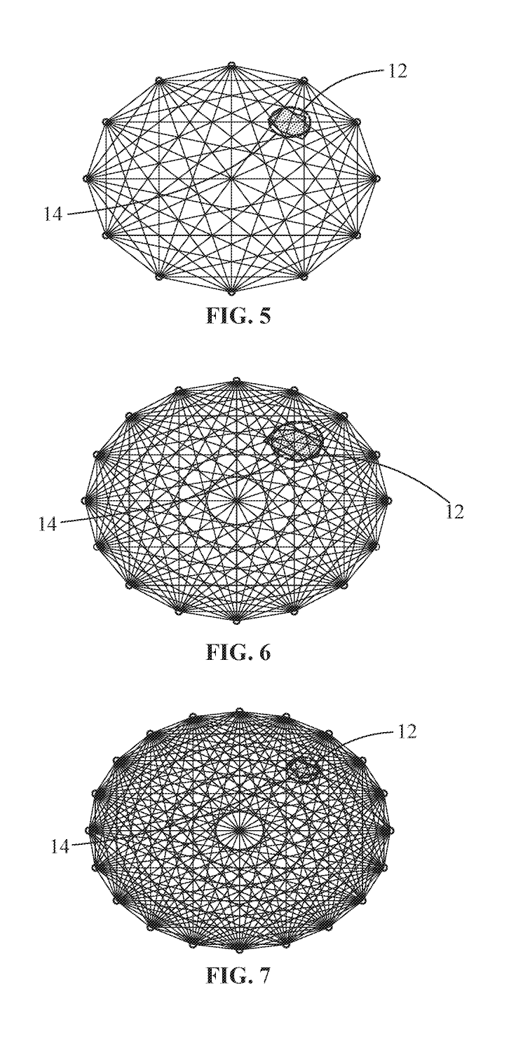

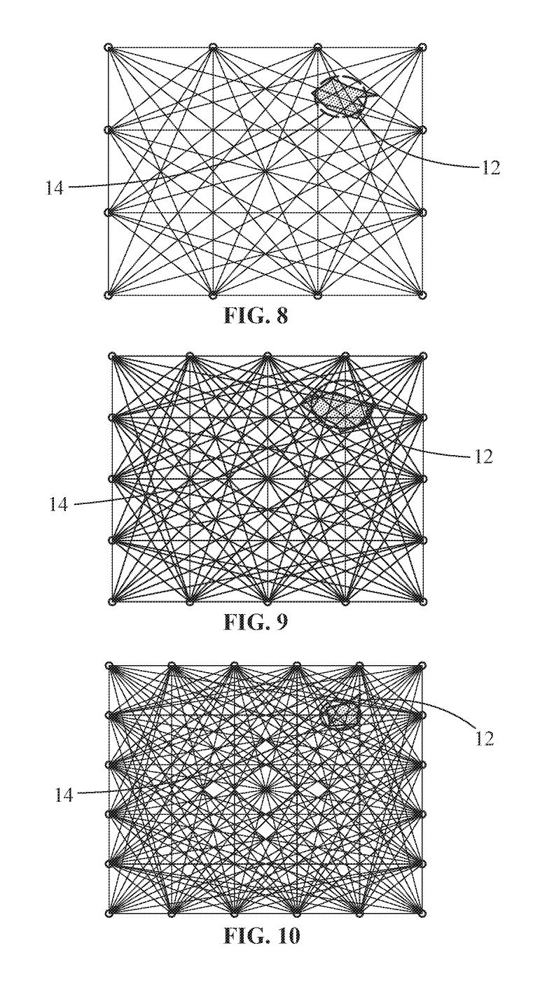

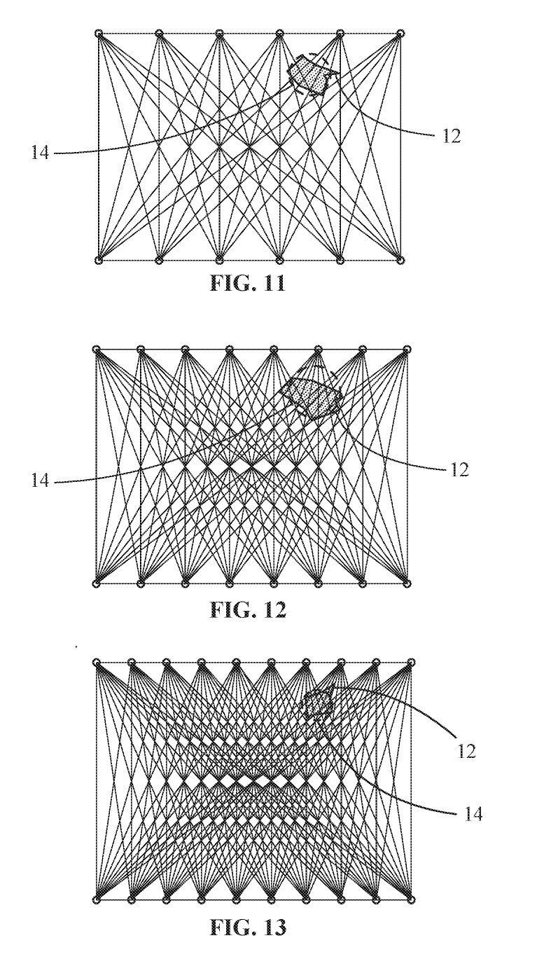

FIGS. 5-13 schematically depict representative sensor networks according to the disclosure to provide a network of sensor communication paths for monitoring a detection area of interest. As show in these drawings, an estimated distributed circle 14 is overlaid on a hypothetical corrosion area 12 in respective sensor networks having the shape of a circle, a square and a rectangle. Of course one of ordinary skill will realize that the actual number of sensors selected may vary based on the intended use and the size of the plate-like structure to be monitored or tested. Thus, while in some embodiments as few as 2, 3 or 4 sensors may be selected to detect the presence of a deviation in thickness, such as corrosion, in some other embodiments scores or even hundreds of sensors may be selected for use according to the disclosure herein.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

1. A method for characterizing a thickness deviation in at least a portion of a plate-like structure, the method comprising:
deploying adjacent to at least a portion of a plate-like structure a sensor network comprising a plurality of transducers, the at least a portion of the plate-like structure having a presumed substantially uniform pristine thickness and formed of an presumed substantially homogenous material and characterized by a known dispersion curvatures that depend on the plate thickness and material properties;
propagating guided waves through the at least a portion of the plate-like structure within the sensor network, wherein the sensor network provides at least four discrete wave transmission paths that traverse the at least a portion of the plate-like structure;
determining the velocity of the guided waves along each discrete wave transmission path based on a predetermined distance between sensors that define the path and the time of flight of the transmitted waves along the wave transmission path;
detecting within the at least a portion of the plate-like structure the presence of any deviation in thickness from the presumed pristine thickness, wherein a deviation in thickness is present when the determined velocity along at least one of the wave transmission paths deviates from an expected pristine guided wave velocity provided by the known wave mode velocities that depend on the relationship between wavelength and plate thickness; and
estimating the location and approximate area of any deviation in the thickness within the at least a portion of the plate-like structure, wherein a deviation in thickness is present when at least four wave transmission paths traverse the deviation as evidenced by a detected deviation of velocity from expected pristine guided wave velocities along at least four wave transmission paths, and whereby the location and size of a patch of thickness deviation is estimated as a circle based on the determined velocities and predetermined distances for each of the transmission paths, and the expected pristine guided wave velocity provided by the known wave mode velocities that depend on the relationship between wavelength and plate thickness.

2. The method for characterizing a thickness deviation in at least a portion of a plate-like structure according to claim 1;
wherein the known wave mode velocities that depend on the relationship between wavelength and plate thickness are provided by guided ultrasound (Lamb) wave group dispersion curves, and
wherein the sensor network is deployed adjacent to the surface of the plate-like structure and the guided ultrasound waves are propagated between pairs of transducers in the sensor network, wherein each transducer is paired with another transducer to provide sets of paired transducers comprising a transmitting and a receiving transducer, wherein the sets of paired transducers provides at least four discrete wave transmission paths, each wave transmission path defined between two paired transducers; and
wherein the velocities of guided waves between the transducers are detected in A₀ and S₀ modes, and wherein deviation comprising a decrease in the thickness will result in a detected reduction in wave velocity, included but not limited to the wave modes including the A₀ mode and the S₀ mode, wherein in the A₀ mode and a detected increase in wave velocity in the S₀ mode.

3. The method for characterizing a thickness deviation in at least a portion of a plate-like structure according to claim 2, wherein the algorithm for estimating the size and location of a thickness deviation patch comprises solving for the coordinates for the center and the radius of a circle that estimates the deviation patch, shown by the relationship Γ(x, y)≈C(x_{c}, y_{c}, r), wherein F is the deviation patch, C is the estimated circle, x_{c}, y_{c} describe the center point of the estimated circle, and r describes its radius, and wherein the distance of the portion of a transducer pair's transmission path through the deviation patch can be approximated and theoretically calculated as distributed circles for each transducer pair, and wherein the circle C variables are determined using a least square optimization problem given as
$$min J ( {x}_{c} , {y}_{c} , r , \overline{V} ) = {\sum }_{k = 1}^{N} {( {\overline{T}}_{k} - {\overline{T}}_{k} )}^{2} , N \geq 4$$
where N is the number of transducer pairs whose transmission paths go through the deviation patch, T̅ₖ is the total and T̅ₖ is the actual time of flight of the transmission of a wave along a transducer pair path associated with the k-th transducers pair, and V̅ is the determined wave velocity.

4. The method for characterizing a thickness deviation in at least a portion of a plate-like structure according to claim 3, wherein the actual time of flight is determined by one of threshold crossing, cross correlation, and wavelet analysis.

5. The method for characterizing a thickness deviation in at least a portion of a plate-like structure according to claim 3, wherein the least square optimization problem is solved by an algorithm selected from a derivative free optimization based Genetic Algorithm, Particle Swarm Optimization, Mesh Grid Optimization, and coordinate search.

6. The method for characterizing a thickness deviation in at least a portion of a plate-like structure according to claim 3, wherein the deviation is a reduction in thickness caused by corrosion.

7. A method for identifying corrosion in at least a portion of a plate-like structure, comprising:
arranging a plurality of transducers along a boundary of a corrosion detection area of the planar structure, the transducers paired to transmit and receive between them along a rectilinear communication path along the planar structure;
actuating the transducers to propagate guided waves between each of the transducer pairs;
capturing and processing the data obtained from the transmissions between the transducer pairs;
analyzing the resultant data, and
wherein, discrete diminution in wall thickness is detected and corrosion patch size is estimated when the boundary of a corrosion patch falls within an area of the plate-like structure that is traversed by at least four transducer pair communication paths.

8. The method according to claim 7, wherein the data from the transmissions between the transducer pairs is analyzed based on time-of-flight straight ray Lamb wave algorithms.

9. The method according to claim 8, wherein the data is analyzed by a least square optimization problem with objective function J, where N is the number of transducer pairs whose communication path traverses at least one corrosion patch, given as:
$$min J ( {x}_{c} , {y}_{c} , r , \overline{V} ) = {\sum }_{k = 1}^{N} {( {\overline{T}}_{k} - {\overline{T}}_{k} )}^{2} , N \geq 4$$

10. The method according to claim 9, wherein optimization problem is solved using an algorithm selected from derivative free optimization based methods including but not limited to Genetic Algorithm, Particle Swarm Optimization, Mesh Grid Optimization, and coordinate search.

11. The method according to claim 10, wherein one or more corrosion patches using multiple distributed circles can be detected and quantified when each patch is traversed by at least four transducer pair communication paths.

12. The method according to claim 11, wherein the plurality of transducers ranges from at least 2 to more than 20 transducers, and wherein the boundary defines a shape that is selected from a circle, a square and a rectangle, and wherein the plurality of transducers is arranged along at least a portion of the boundary of the corrosion detection area.

13. The sensor network according to claim 7, the plurality of pairs of transducers comprising more than four paths passing the corrosion area, at least one of which is passing the corrosion area for detection.

14. A sensor network for corrosion detection in a plate-like structure, comprising:
a plurality of at least four pairs of transducers arranged along a boundary of a detection area of at least a portion of a plate-like structure, each transducer configured as one of:
a transmitter that transmits guided ultrasound wave signals;
a receiver that receives guided ultrasound wave signals; and
a transmitter and a receiver (a dual mode transducer)
the plurality of transducers configured to enable communication of guided ultrasound waves through the wall of the plate-like structure along a rectilinear path between paired transmitter and receiver transducers;
the boundary defining a detection area that is at least the size of a preselected minimum detection area, such that at least four independent transducer pair paths cross the preselected minimum detection area; and
a transducer controller system for actuating the transducers, capturing and processing data obtained from the transmissions between paired transducers, and analyzing the data to do one or more of:
detect and provide an estimated location of each of one or more corrosion patches within the detection area of the plate-like structure;
provide an estimated size of each of the one or more detected corrosion patches; and
provide an estimated reduction in thickness of the wall of the plate-like structure within each of the one or more detected corrosion patches, such estimating provided using optimization of a proposed error function.

15. The sensor network according to claim 14, wherein the boundary defines an area having a shape that is selected from a circle, a square and a rectangle.

16. The sensor network according to claim 14, wherein adjacent transducers are spaced substantially equidistant.

17. The sensor network according to claim 14, the transducers selected from piezoelectric stack transducers, shear piezoelectric transducers, acoustic transducers, electromagnetic acoustic transducers, magnetostrictive transducers, non-contact ultrasound transducers, including but not limited to Laser based ultrasound equipment, air coupled, and EMAT transducers, and combinations of these.

18. The sensor network according to claim 14, wherein one or more of each of the plurality of transducers may pair with one or more of the other transducers.

19. The sensor network according to claim 14, wherein the plurality of transducers is either fixed on a surface of the plate-like structure, or is portable, and two more of the transducers can be removably positioned on a surface of the plate-like structure.

20. The sensor network according to claim 20, wherein arrangement of each transducer relative to the others is adjustable to enable variable adjustment of the boundary of the detection area.

21. The sensor network according to claim 20, further comprising mechanical systems including robots that are actuatable to move the transducers for applications that include but are not limited to Pig for pipeline inspection.
